(19) United States
(12) Patent Application Publication
(10) Pub. No.: US 2008/0150698 A1
(43) Pub. Date: Jun. 26, 2008

(54) Radio frequency identification tag with passive and active features

(75) Inventors: Geoff Smith, Brisnam (AU); Peter Scott Single, Sydney (AU)

Correspondence Address: BSTZ/G2 MICROSYSTEMS, INC., 12400 Wilshire Boulevard, Seventh Floor, Los Angeles, CA, 90025-1030, US

(73) Assignee: G2 Microsystems, Inc.

(21) Appl. No.: 11/645,364

(22) Filed: Dec. 26, 2006

(51) Int. Cl. H04B 7/00

(52) U.S. Cl. 340/10.4

(57) ABSTRACT

A radio frequency identification (RFID) tag is described that has both passive RFID tag features and active RFID tag features. In one example, the tag has a first radio transponder to transmit by backscattering a received signal, a second radio transponder to operate on a multiple access wireless network, and a connection from the first radio transponder and to the second radio transponder to transfer information about communications over the multiple access wireless network from the first radio transponder to the second radio transponder.

### BACKGROUND

1. Field

The present description relates to the field of radio frequency tags for inventory and tracking and in particular to combining aspects of passive tags and active tags into a single system.

2. Related Art

Radio Frequency Identification (RFID) tags are being developed for use in inventory tracking and monitoring and in production management. RFID tags are typically small, inexpensive electronic radio devices with a passive transponder and an integrated circuit programmed with a unique identification number. In a warehouse or shipping context, RFID tags may be located on items, on boxes, on containers or on pallets for identification and tracking. RFID tags have also been proposed as a replacement for barcodes to identify items.

An RFID tag reader of the type typically used with passive RFID tags has a radio transponder that reads the unique identification number programmed into the RFID tag. An RFID tag reader may be configured either as a handheld unit or a fixed-mount device. The reader emits radio waves in ranges of anywhere from a few centimeters to about 40 meters, depending on the particular protocol and allocated wavelengths for the location and application. When an RFID tag passes within range of the reader, it receives the reader's activation signal. This signal energizes the RFID tag and enables the tag to transmit its identification number, that is encoded on its integrated circuit, to the reader. The reader decodes this number, that may be passed to a host computer for processing.

A passive RFID tag has no internal power source and relies on an external source to provide power. One such source is the RF energy transmitted by the tag reader. Due to the limited amount of power available, the memory and processor resources of a passive tag are also typically limited. The data stored on a passive RFID tag is generally little more than a unique identifier for the item. Such a tag may serve as an electronic bar code that can be read from moderate distances and through other objects.

An active RFID tag has an internal power source. This makes active RFID tags more expensive and bulkier than passive RFID tags limiting their usefulness for tracking inexpensive items. On the other hand, an active RFID tag may be provided with more functions and more data memory because of the larger amount of power available.

Active RFID tags have been developed that include wireless communication capabilities, position determination capabilities, and environmental sensing capabilities. Such a sophisticated tag may be able to join a wireless network and send its sensor data as well as its location to wireless access points in a facility. Tags that are designed to use the IEEE (Institute of Electrical and Electronics Engineers) 802.11 protocol may sometimes be referred to as WiFi tags. Tags and tag readers have also been developed to run on a variety of wireless standards other than IEEE 802.11, including proprietary standards. However, since the active RFID tag relies on a battery, considerable effort is made to reduce the power consumption of an active RFID tag. The result is that the active RFID tag is usually turned off and can neither be used or configured.

Mobile Resource Management (MRM) systems are designed to locate, monitor and track assets. They often include a combination of a real-time location system, that might use mechanisms such as GPS (Global Positioning System), 802.11, RSSI (Returned Signal Strength Indication) location, or the TDOA (Time-Difference-of-Arrival) mechanisms proposed in the (draft) ISO (International Standards Organization) 24730.2 standard.

In an RSSI location system, a tag transmits a signal that is received at multiple fixed receivers within a facility. By measuring signal strength at each receiver, and applying triangulation, the location of the tag can be determined. Some RSSI systems use well known protocols such as IEEE 802.11b—in which the tag can engage in bidirectional communication with the wireless networks. However, some wireless networks use sophisticated security mechanisms to stop unauthorized users from accessing the network—these can make it difficult to distribute encryption keys to allow a wireless tag to obtain access to the network.

### SUMMARY

A radio frequency identification (RFID) tag is described that has both passive RFID tag features and active RFID tag features. In one example, the tag has a first radio transponder to transmit by backscattering a received signal, a second radio transponder to operate on a multiple access wireless network, and a connection from the first radio transponder and to the second radio transponder to transfer information about communications over the multiple access wireless network from the first radio transponder to the second radio transponder.

### BRIEF DESCRIPTION OF THE DRAWINGS

Embodiments of the present invention may be understood more fully from the detailed description given below and from the accompanying drawings of various embodiments of the invention. The drawings, however, should not be taken to be limiting, but are for explanation and understanding only.

FIG. 1 is a block diagram of a passive RFID tag and tag reader according to an embodiment of the invention;

FIG. 2 is a block diagram of an active RFID tag or WiFi client and wireless access point according to an embodiment of the invention;

FIG. 3 is a block diagram of a combined passive and active RFID tag, tag reader, and wireless access point according to an embodiment of the invention;

FIG. 4 is a block diagram of a tag reader or wireless access point according to an embodiment of the invention;

FIG. 5 is a diagram of an example memory layout for a passive RFID tag according to an embodiment of the invention;

FIG. 6 is a block diagram of a sequence of message exchanges involving the memory layout of FIG. 5;

FIG. 7 is an example process flow diagram of sending and executing commands using a tag reader and an RFID tag according to an embodiment of the invention; and

FIG. 8 is a diagram of a tag coupled to the Internet through a tag reader and a network.

### DETAILED DESCRIPTION

A MRM (mobile resource management) system may be provided with the ability to communicate with a RFID (Radio Frequency Identification) tag using existing infrastructure. The communication may include obtaining reports from the tag, storing data in the tag, and reprogramming the tag. An existing system that is physically designed to scan standard ePC (electronic Product Code)-style RFID devices may accordingly be adapted to access the richer set of functionality provided by more advanced RFID Tags.

In one example, a system may be constructed using aspects of a semi-passive RFID tag (for example a Gen 1 Class 0+ or Gen 2 tag, generations and classes are defined by ePC Global Inc.) integrated with aspects of a fully active IEEE 802.11 (a group of standards 802.11x for wireless networking promulgated by the Institute of Electronics and Electrical Engineers)—based MRM tag. The fully active 802.11 (or WiFi) tag may include a programmable microprocessor with a TCP/IP (Transport Control Protocol/Internet Protocol) stack, a sensor interface for telemetry and other applications and memory.

A combination of WiFi functions and RFID functions allows for many additional capabilities:
A tag application may be re-programmed within range of a WiFi terminal, for example as it passes through a standard RFID choke-point.
A tag may generate a report and send it to the tag's owner as the tag passes through an RFID choke-point. The report may be sent using a full TCP/IP stack over the RFID physical layer to send data to a remote location.
ePC parameters may be updated over the WiFi network, or based on some application running on the tag's microprocessor. The choke-point may be used, accordingly, to sort items that need attention (e.g. items that have passed their “use-by” date) from those that do not need attention.
WiFi network keys may be provided to tags as they enter a facility. This may be used to allow secure communications mechanisms to be used with the tags.

These are just some examples of capabilities that such a combination may provide. Other capabilities and uses may be developed or provided for depending on the particular application and objectives for the tag and the system within which it is used. Additional capabilities and functions are described below.

### Hardware Structures

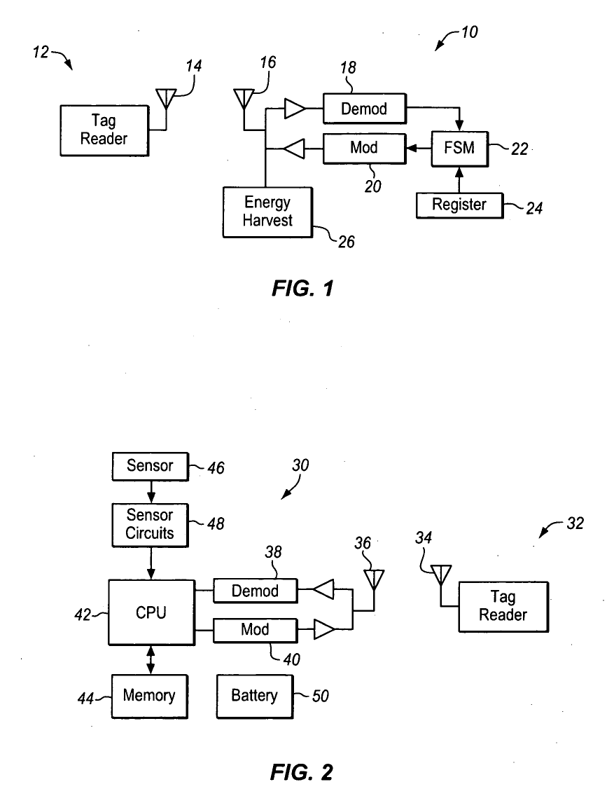

FIG. 1 shows an example of working parts that may be included in a passive RFID tag. FIG. 1 may represent an ePC Generation 1 Class 0 or 1 tag, or an ePC Generation 2 tag, or any of a number of other RFID tags. These specifications define the physical and logical requirements for a passive-backscatter, Interrogator-talks-first (ITF), RFID system using interrogators or readers and tags or labels.

The passive RFID tag 10 works in the proximity of and in conjunction with a tag reader or interrogator 12 that includes an RF antenna 14 for sending RF energy to and receiving RF energy from the tag.

An interrogator transmits information to a tag by modulating an RF signal in, for example, the 860 MHz-960 MHz frequency range. The tag receives both information and operating energy from the RF signal. A passive tags is one that receives all of its operating energy from the interrogator's RF waveform.

An interrogator receives information from a tag by transmitting a continuous-wave (CW) RF signal to the tag; the tag responds by modulating the reflection coefficient of its antenna, thereby backscattering an information signal to the interrogator. The system is ITF (Interrogator-Talks-First), meaning that a tag modulates its antenna reflection coefficient with an information signal only after being directed to do so by an interrogator.

Interrogators and tags are not required to talk simultaneously; rather, communications may be half-duplex, meaning that interrogators talk and tags listen or vice versa.

The tag 10 includes its own antenna 16 to communicate with the tag reader. The antenna is coupled to a receive chain 18 including a demodulator for signals received from the antenna. The antenna is also coupled to a transmit chain 20 that includes a modulator for signals to be transmitted over the antenna. The receive chain and the transmit chain both include a respective gain stage and are both coupled, for example, to a FSM (Finite State Machine) 22, however other devices from direct registers to microcontrollers and processors may be used.

In a simple example, the FSM is coupled to an ID (identification) number register 24 that holds the ID number for the tag. When queried through the receive chain, the FSM will retrieve the ID number from the register, modulate it and transmit it through the transmit chain and the antenna. Additional registers may be used to store additional values and the values may be fixed or rewriteable.

An RF signal transmitted by a tag reader and received by the tag's antenna is demodulated. The subsequent bit stream may be designed to control the FSM that controls the transmit modulator. The modulator backscatters data via the antenna. This provides for two-way communication.

In one example, at least some of the tag functions (e.g. tag singulation) are based on whether the signal received by the antenna matches a pre-determined code stored in the tag. The register 24 may in this instance be used to compare the incoming data stream to the tag's unique number. The result or the comparison may be used to control the tag back-scatter or be used by the tag to cause it to progress through its state transition diagram.

Singulation allows the reader to distinguish the backscattered signal of a tag from all of the tags around it. There are a variety of different mechanisms for singulation including tree walking, in which a tag responds based on its serial number and ALOHA, in which a tag resends its data after a random wait time.

The tag also has an energy harvest circuit 26 coupled to the transmit and receive chains. This circuit harvests energy received by the antenna from outside sources of RF energy including the tag reader to power the tag circuitry, including the FSM, the receiver and the transmitter. The energy harvester may be used to eliminate any requirement for another power supply, such as external current or a battery. This also eliminates any maintenance of the power supply or a battery allowing the tag to operate indefinitely.

FIG. 2 shows an example of working parts that may be included in a WiFi client that is being used to sense its environment and report via its WiFi link. Such a device may be controlled by a CPU (Central Processing Unit) or microcontroller executing instructions in a semiconductor memory.

The WiFi client 30 communicates with a wireless access point 32 that includes an antenna 34. The antenna of the access point is able to communicate with an antenna 36 of the WiFi client 30. The WiFi client has a receive chain 38 with a demodulator and a transmit chain 40 with a modulator that are both, in this example, coupled to a CPU 42. The CPU is coupled to a memory 44 for storing data, intermediate values and programming code. The WiFi client may also have one or more sensors 46 coupled through driver and conversion circuitry 48 to the CPU.

A battery 50 may be used to power the WiFi client, however, any other type of energy storage or generation cell may be used instead of, or in addition to the battery including, a solar cell, energy harvester 26 or other power supply. Unlike the energy harvester of the passive RFID tag, the battery of this example of an active RFID tag may require replacement or recharging.

Data may be transmitted to the tag 30 from the wireless access point (AP) 32. Received data may be demodulated in the receive chain 38 and presented to the CPU 42. The CPU may be used to control the modulator in the transmit chain 40 to send data back to the AP. The received data may be a poll or query, values to store in the memory 44 or new programming instructions. It may also be parameters to be used in running the programs in the memory. For example, the AP may send timing parameters to use in determining when to measure a sensor value or send a report.

In one example, the memory includes configuration registers that may be used to select options and values for programs executed by the processor. The configuration registers may include addresses, port numbers, encryption keys, timing or clock values, protocol settings and values, among other parameters.

Using the sensor (for example a push button, a thermometer, an accelerometer, a location system, etc.) and the sensor circuit (for example a circuit to supply current to monitor the push button) the CPU may monitor the state of its environment and send data to the AP. The sensor may monitor temperature, pressure, humidity, location, impacts or shaking with an accelerometer, or any other environmental parameters. The sensor or sensor circuit may also track these physical parameters over time and determine whether a specified range or threshold is satisfied. For example, the sensor circuit may determine whether a tag has been kept within a specified temperature range.

Depending on the programming, the WiFi client, as an active RFID tag, may send a periodic ID signal or respond to polling signals according to any of a variety of different protocols or routines. The position of the tag and the best connections for RF communication may be determined in a variety of different ways. In one example, a group of APs measure the RSSI (Received Signal Strength Indicator) of the tag to triangulate the position and determine the best AP for communications.

Both passive and active RFID tags may be operated in one of at least two states, a low-power sleep state and a high-power active state. When active, both devices may provide an identification number upon request.

The power supply used by either device leads to a few differences. A battery-powered WiFi client may be much more sensitive to received signals than an RF-powered RFID tag and so the transmit and receive ranges may be much greater. On the other hand, the passive RFID tag consumes no energy when it is not being used. The WiFi client uses battery power to maintain a standby state, to listen for polls and to determine if it is within the range of an AP.

Due to the amount of power available from the power supply, an RF-powered RFID tag usually performs one simple fixed function, backscattering received radiation to send an identification number. On the other hand, the battery-powered WiFi client may be fully programmable and may execute quite complex stored programs.

The nature of the power supply also leads to different typical modes of operation. In a typical application, the passive RFID tag only wakes when illuminated by RF energy transmitted from the antenna of a tag reader, while the active WiFi client can initiate activity, sense its environment and send reports.

The available transmit and receive power may also affect the range of each device, as may the RF modulation technology that is used. WiFi networks usually provide coverage over 100% of an area so that a WiFi client can be tracked as it moves through the area. Readers for passive RFID tags are usually located only in certain locations, typically choke points, such as doorways and corridors. A passive RFID tag is often only located by a reader when it passes by such a location.

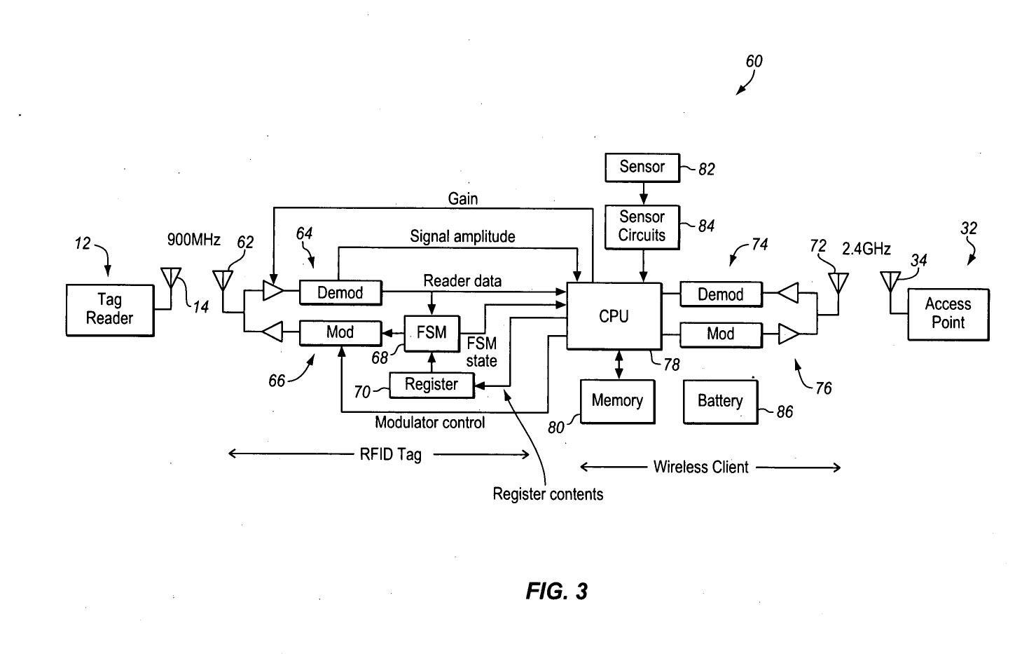

FIG. 3 shows an example of combining functions and features of the example devices of FIGS. 1 and 2 into a single device. By allowing the two sides to pass signals between them, additional new benefits may be obtained. Such a device may be produced from a single silicon chip or by coupling two discrete components.

The passive RFID side of the tag 60 works in the proximity of and in conjunction with a tag reader 12 that includes an RF antenna 14 for sending RF energy to and receiving RF energy from the tag. The active RFID side of the tag 60 works in the proximity of a wireless access point 32 that includes an antenna 34. The relative proximity of the tag reader and access point may vary depending on the nature of the wireless link used for each. Typically, but not necessarily, the access point will communicate with the tag at greater distances than the tag reader.

The passive side of the tag includes its own antenna 62 to communicate with the tag reader. The antenna is coupled to a receive chain 64 including a demodulator to receive signals and to a transmit chain 66 that includes a modulator to transmit signals. The receive chain and the transmit chain are both coupled to a FSM 68 or similar device. The FSM is, in turn, coupled to an ID (identification) number register 70 that holds the ID number and other information for the tag.

On the active side of the tag, the antenna of the access point is able to communicate with another antenna 72 of the tag 60. The WiFi side of the tag also has a receive chain 74 with a demodulator, and a transmit chain 76 with a modulator that are both coupled to a CPU 78. The CPU has access to an external memory 80 similar to that of FIG. 2 and to one or more sensors 82 coupled through driver and conversion circuitry 84 to the CPU. A battery or other energy cell 86 is used for power.

The CPU 80 may also be coupled to the passive elements of the tag including the FSM 68, the register 70, and the transmit and receive chains 66, 64. The connections may allow for CPU control of the modulator and demodulators, gain stages and other components of the passive portion of the tag.

Through the CPU, information may be passed from the passive tag portion to the active WiFi tag portion. This information may include, the RFID signal amplitude, the RFID reader data, the FSM state, and any data received from the tag reader. Similarly, information may also be passed through the CPU from the active portion to the passive portion, such as the RFID tag front-end gain, the RFID tag number, and the data scattered by the tag. Any of the information passed between the two portions may be stored in the register 70, or the memory 80, or both. Information stored in the register may be available to the passive transceiver quickly even when the CPU is powered down or in a sleep state. Information stored in the memory may be more quickly accessible to the CPU when the CPU is active.

FIG. 4 shows an example tag reader or wireless access point in more detail. “Tag reader” is typically used to refer to a radio device, operating in the 900 MHz range that reads ePC numbers from passive RFID tags. “Access Point” is typically used to refer to a node in an IEEE 802.11-based wireless network. However, the present invention is not limited to these particular standards, frequencies, and protocols. An active RFID tag may be able to communicate with an access point, if configured to behave like a node in such a network. The basic configuration of both a tag reader and an access point, however, may be similar. As a result, typical tag reader functions may be performed using access point wireless interfaces and protocols, while typical access point functions may be performed using tag reader wireless interfaces and protocols. In the present application, any reference to a tag reader may apply also to an access point and vice versa.

In the example of FIG. 4, a tag reader 90 has an antenna 92 to communicate using any of a variety of different protocols with active or passive RFID tags or both. The reader has a receive chain 94 with a demodulator and a transmit chain 96 with a modulator that are both coupled to a processor such as a CPU 98. The CPU assembles packets for transmission and parses packets that are received. The CPU has a local memory 100 for instructions, software, and data. The CPU is further coupled to a network interface 102 to allow the tag reader to communicate with a shipping, fulfillment, manufacturing, or inventory data management system.

The network interface may couple through a wide area or local area network to reporting stations, databases or tracking stations. Through the network, the tag reader may report events and data received from the tag and also obtain data or parameters to be written to the tags. In addition, the tag reader may cooperate with other tag readers or systems on other tag readers to determine information or parameters to be written to the tags. The tag reader may also independently determine information to be written to the tags. For example, a tag reader may measure a RSSI (Received Signal Strength Indication) from a tag and then determine a transmit or receive power adjustment parameter to send to the tag. The tag reader may include network components, such as routers and switches, environmental sensors, and facility equipment interfaces (not shown) to allow the reader to perform additional functions.

The wireless devices discussed above, such as access points, WiFi clients and RFID readers may be very similar. Each may contain a micro-processor, memory, programs, a transmitting antenna and a receiving antenna. Further, the particular frequencies, e.g. 2.4 GHz for WiFi activities and 900 MHz for RFID activities may be changed depending on the application.

### Communications Extensions

Using either the tag reader or the access point interface, the tag of FIG. 3, may be used to provide additional functions and uses in a variety of different situations. In order to read data from WiFi clients, access points may be mounted in a variety of different locations in a building, warehouse, ship or other facility to create a WiFi network. On the other hand, in order to read RFID tags, RFID readers are typically used and these are typically not intended to provide complete coverage, but placed at choke points. However, there may be areas in which a building might have incomplete WiFi coverage, and there may be areas with no RFID tag readers. Using transceivers for both types of communications, the tag of FIG. 3 may function in any area that has either a tag reader, or an access point, or both. In most installations both the WiFi access points and the RFID tag readers may be connected to a wired network that uses the a networking protocol, such as Ethernet or the IEEE 802.3 protocol.

An RFID system may alternately send data to a tag and read data from the tag. The microcontroller of the tag may respond to RFID tag data and control RFID tag data. By coupling the microcontroller to the 900 MHz RFID link, the 900 MHz link may be used as a general-purpose data link between an RFID tag reader and the microcontroller on the WiFi client side of the tag.

In addition, a high level communications protocol such as 802.3, or UDP may be encapsulated by an RFID protocol such as the ePC Gen 2 protocol. A protocol such as TCP/IP can then be overlaid on 802.3 so that a Class 4 tag can deliver a report to a device on the Internet through an RFID reader without an access point being required.

Higher level protocols may be accommodated using the read and write capability of an RFID protocol to transfer packets of data between the reader and the tag. The Gen 1 Class 0 protocol and the Gen 2 Class 1 protocol as defined by ePC Global Inc, for example, provide for such a read and write capability. In one example, two areas of memory within a user-defined memory area may be reserved for this purpose.

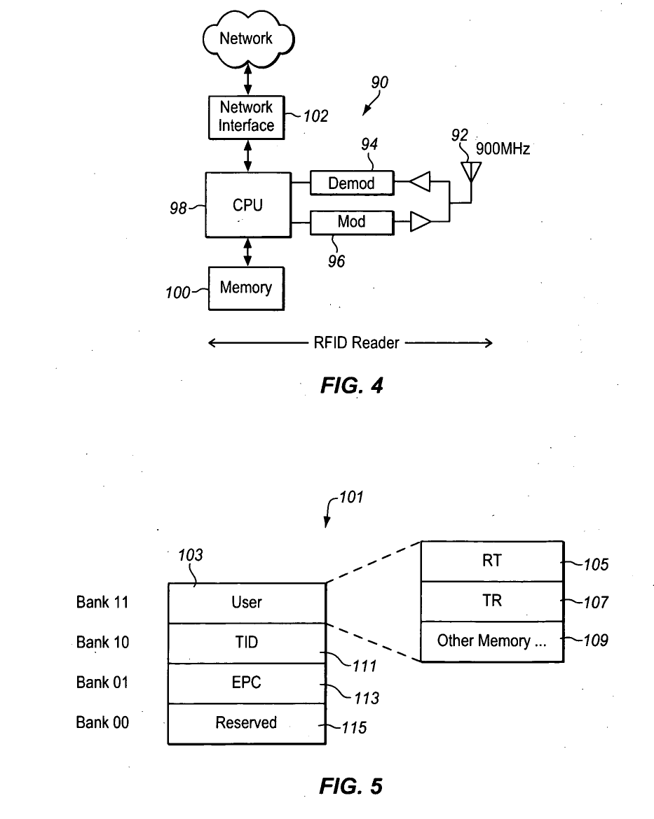

FIG. 5 shows an example memory layout of a Gen 2 Class 1 tag. This memory may correspond to the registers 24, 70 described above or may be in a different location or configuration. The memory 101 has four banks labeled (in binary) from 00 to 11. Two areas of the memory are used for the data link with a tag reader. These are in the user space 103 assigned to Bank 11 of the memory. The first area 105 is called RT for reader-to-tag data and the second area 107 is called TR tag-to-reader data. The tag reader writes to the RT area and reads from the TR area. The tag reads from the TR area and writes to the RT area.

The user bank 103 of the memory 101 also includes an area for other memory 109 that may be used for user-defined and other data that is not necessary to the communications described herein. The other three memory banks include a TID (Tag Identification), an EPC area to store the electronic product code, and a reserved section.

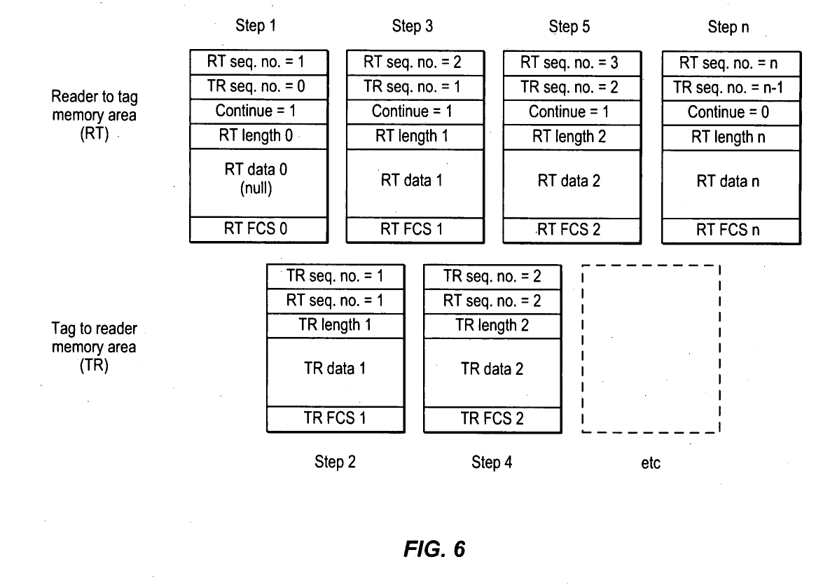

A simple, packet-based communications protocol may be operated using such a memory organization as shown, for example, in FIG. 6. By convention, the tag reader initiates a communication by writing to the RT memory area with a block of data. This write operation is diagrammed as the Step 1 block in FIG. 6.

In the Step 1 block, the reader assigns an RT (reader-to-tag) sequence number of “1” indicating that the reader is requesting block 1 of data from the tag. The reader assigns a TR sequence number of “0” that, by convention, indicates that the subsequent data was not requested by the tag. It sets “Continue” to “1” indicating that the reader wishes to continue with the link. The reader adds a frame message length (RT length 0) and a frame check sum (RT FCS 0). There is no reader to tag data in this first frame, so this frame communicates the message “I am available for communications, but have not sent you any data”. The names, sequences, and values described above are provided as part of the example. Embodiments of the invention may be adapted to work with other protocols, depending on the particular application.

When this write operation is complete, if the tag wishes to communicate using this facility the tag responds to the request by writing to the TR memory area as diagrammed in the Step 2 block. In the Step 2 block, the TR sequence number is set to “1” indicating that it has provided the frame requested by the reader. The tag sets the RT sequence number to “1” indicating that it is requesting a frame. The tag adds a length field to indicate how much data follows, then it provides the data and finally an FCS. The data contains all the information necessary for the reader to construct an 802.3 data frame according to the tag's instructions. Although the 802.3 frame contains its own frame-check sequence, the tag provides an additional one to protect the envelope constructed around the 802.3 frame by the tag.

While this is occurring, the reader waits for a specified time using, for example, a counter. This provides the tag with the opportunity to write data to the TR memory. The reader then reads from the TR area of memory. It recognizes the sequence number as corresponding to the requested data and can read the data. It can check the frame integrity from the FCS. If the FCS does not match, it can re-read the data from the tag.

The reader can then transmit the data onto the 802.3 network according to the data contained in the packet. The reader can listen for packets on the 802.3 network addressed to the tag. When such a packet is received, the reader writes the contents of the packet to the RT data 1 memory area, as in Step 3. Again this data is encapsulated and contains an FCS.

The process of reading and writing to the memory may continue as long as the “Continue” flag is set to “1.” When the tag receive a packet in which the “continue” bit is set to 1, but the tag has no data to send to the network, it still increments the sequence number, and leaves the “Continue” flag set to 1, but writes no data in the packet data area. A similar convention is used when the tag is sending more packets to the network, than the network is providing to the tag. By convention, the tag and reader send packets of data to each other until either the reader or the tag decides to terminate the connection and sets the “Continue” flag to “0.” With that message, the reader delivers the last frame of data requested by the tag.

The exchanges of FIG. 6 illustrate a bi-directional half duplex communications protocol between the tag and the reader with an additional protocol being encapsulated in the packet exchange process. One such protocol is IEEE 802.3 (Ethernet), however, other protocols such as PPP may be used instead. The data packets stored in the TR and RT memory areas may be modified to satisfy the requirements of the other protocol.

The tag and reader may use any of a variety of different mechanisms to enter an 802.3 mode of communication. For example, an area of memory (or a set of addresses) may be set aside specifically for this task. Alternately, a field in the “other memory” area (109 of FIG. 5) may be reserved for this. Once a protocol such as 802.3 or PPP has been established, then higher-layer protocols such as TCP/IP may be run.

The translation from the RT data area to the 802.3 protocol and vice-versa may be straightforward: for example, a 10BASE5 802.3 protocol allows a packet length of 1518 octets, so if the RT data area and TR data area were both 1518 bytes, then the bytes could correspond on a simple 1:1 basis. However, a variety of other simple or complex translations may be used. Since the RT packets and TR packets include length fields, the mechanism may also be adapted to handle shorter packets.

Communicating higher level protocols using the conventional interface for passive RFID tags provides more functions without requiring a network of access points. In addition, it also allows for power conservation and interference reduction, both in the reader and in the tag. The passive tag communications system is typically a short range, low power communications system, with simple short packets. The tag and reader can communicate using much lower power than when using a typical access point protocol. This reduces the power demands on both sides and also reduces the RF energy inserted into the communications environment that might cause interference with other readers or other unrelated communications equipment.

As a further benefit, the passive RFID side of the tag of FIG. 3 is designed to operate using only power from the energy harvester. Accordingly, the radio transponder and the memory banks may be operated using no battery power at all. Even if the higher level protocol functions or the microprocessor require battery power, the transponder may be operated using little or no battery power. This greatly reduces the power demands for the battery.

### Configuration Settings

Many of the approaches, techniques and structures described above may also be used to send other types of commands or configuration settings to an RFID tag. For example, a variety of different commands may be sent through the passive side of the tag of FIG. 3 to cause changes in the active side of the tag. One particularly useful command is an enable/disable command. Such a command may be used to wake up an active tag that is shut down or in a standby mode. It may also be used to shut down a tag and save battery power.

Many active tags are shut down most of the time and only wake periodically to sense the local environment and listen for any pages or commands. The active tag is unavailable when it is shut down. On the other hand, a passive tag may always be activated by sending RF energy to the energy harvester. In the combined tag, a message may be sent to the active side through the passive side even when the active side is shut down. Allowing the active side to be activated through the passive side presents an additional benefit that the active side may be programmed to be shut down for longer periods or shut down more completely, since it may be activated upon demand.

Similarly, the tag may be commanded to shut down for some period of time and not periodically wake up. This may be useful if the goods to which the tag is attached are moved into long term storage, or if the goods are moved into an environment that is sensitive to RF energy, such as an airplane cargo hold.

In the same way, a variety of other parameters may be set through the passive side of the tag. These parameters may include wake up and sleep schedules, communication addresses and parameters, identification information and location data to store in a memory for reporting later.

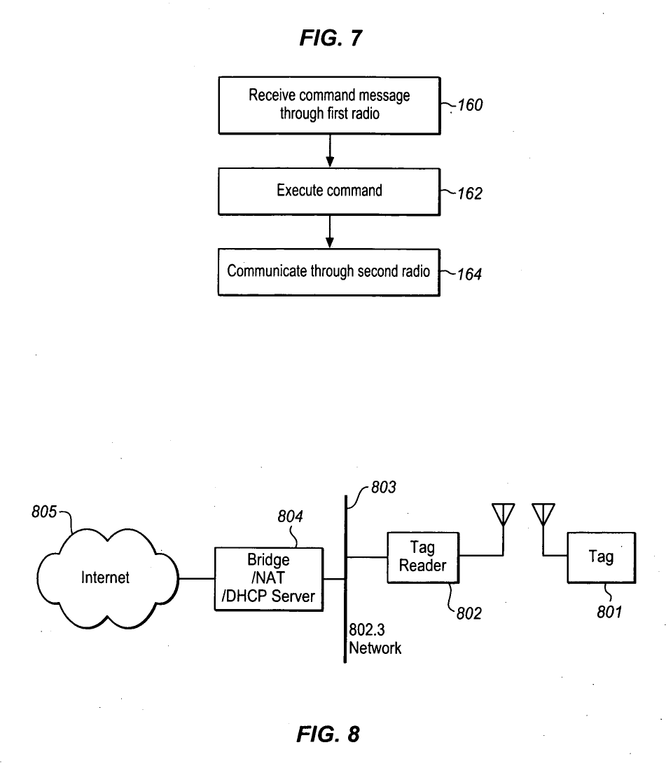

FIG. 7 shows a sequence of operations to communicate and execute commands using the apparatus described above. Beginning at block 160, a command message is received over a first radio communications protocol, for example an ePC Gen 2 protocol. The reception may also be in unique hardware for the first protocol. As shown, for example in FIG. 3, there is a separate transceiver and antenna for the passive side of the tag. However, it may be possible to combine the transceivers depending on the particular implementation. The unique hardware may, for example, be the passive side of a combined tag. For the passive side of the tag, the message is received by harvesting the energy from the configuration message to power the reception of the message. This harvested energy also powers the microcontroller and the memory to write parameters into a memory.

The command message relates to communicating over a second radio communications protocol and may contain only a command or a set of parameters. The parameters may, for example, be used in configuration registers for the active side of the tag. The parameters may include internet protocol settings, such as a secure socket identification, an access port name, encryption keys, username and password pairs or any other parameters. The command message may alternatively be a power control message as described above. This message may be a command to power up or power down, or it may be used to change power control settings such as wake times, sleep times, wait intervals and similar parameters.

At block 164, the second radio communications protocol is used to communicate in accordance with the command message. In the examples above, the second radio communications protocol uses a second radio transceiver. However, the number and configuration of the transceiver may be modified depending on the particular circumstances. In one example, the command message is written into the configuration parameters for the active side of the RFID tag. Then, when the active side is activated, it uses the new values from the configuration registers for the appropriate process. In another example, the command message is a power control message that activates the active side of the RFID tag through the passive radio transceiver.

FIG. 7 shows how a tag reader may provide a bridge between a tag and an 802.3 network, and thereby provide a tag with a path to the Internet. The tag 1001 communicates using an ePC-style protocol to a reader 1002 that is connected to a network 1003. The tag 1001 allows the reader 1002 to write to the tag, and the tag must be able to change the data to the reader. This network may connect to the Internet 1005 via a bridge device 1004 or in any of a variety of other ways. The bridge device also provides network-address translation (NAT) and dynamic host control protocol (DHCP) services.

A lesser or more complex passive transceiver structure, active transceiver structure, tag reader and system design may be used than those shown and described herein. Therefore, the configurations may vary from implementation to implementation depending upon numerous factors, such as price constraints, performance requirements, technological improvements, or other circumstances. Embodiments of the invention may also be applied to other types of inventory tracking and control systems and different RFID systems that use different types of transponders and protocols than those shown and described herein.

In the description above, numerous specific details are set forth. However, it is understood that embodiments of the invention may be practiced without these specific details. For example, well-known equivalent circuits, components, assemblies and configurations may be substituted in place of those described herein, and similarly, well-known equivalent techniques, processes, and protocols may be substituted in place of the particular techniques described. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. An apparatus comprising:
a first radio transponder to transmit by backscattering a received signal;
a second radio transponder to operate on a multiple access wireless network; and
a connection from the first radio transponder and to the second radio transponder to transfer information about communications over the multiple access wireless network from the first radio transponder to the second radio transponder.

2. The apparatus of claim 1, wherein the connection comprises a processor coupled to an identification register of the first radio transponder to allow an identification number in the identification register to be transmitted through the second transponder.

3. The apparatus of claim 1, further comprising an energy storage cell coupled to the first radio transponder and the second radio transponder to power communications using the first radio transponder.

4. The apparatus of claim 3, further comprising an energy harvester coupled to the first radio transponder to harvest energy received by the first radio transponder to power the first radio transponder and wake the apparatus.

5. The apparatus of claim 1, further comprising:
a sensor to collect sensed data; and
a memory coupled to the connection to store the sensed data,
wherein the sensed data is sent through the connection and the first radio transponder.

6. The apparatus of claim 5, wherein the first radio transponder sends the sensed data in response to a radio signal received by the first radio transponder, the received signal further being harvested by an energy harvester to provide power to send the sensed data.

7. The apparatus of claim 5, wherein the sensor comprises at least one of a clock, a thermometer, a hygrometer, an accelerometer and a position sensor.

8. The apparatus of claim 1, wherein the connection includes a processor that has a high power state and a low power state and wherein the processor switches to the low power state in response to a command received by the first radio transponder.

9. The apparatus of claim 1 further comprising configuration registers to store parameters to control operations of the second radio transponder wherein the first radio transponder receives parameters for storing in the configuration registers.

10. The apparatus of claim 9, wherein the parameters comprise internet protocol settings.

11. The apparatus of claim 9, wherein the internet protocol settings include a secure socket identification, an access port name, and encryption keys.

12. The apparatus of claim 9, wherein the parameters comprise transponder operation parameters.

13. The apparatus of claim 12, wherein the transponder operation parameters include power control parameters.

14. The apparatus of claim 1, further comprising a processor to emulate wireless local area network communications through the first radio transponder.

15. The apparatus of claim 1, further comprising a processor to transfer information about communications over the first radio transponder from the second radio transponder to the first radio transponder.

16. The apparatus of claim 15, further comprising configuration registers to store parameters to control operations of the first radio transponder wherein the second radio transponder receives parameters for storing in the configuration registers.

17. The apparatus of claim 16, wherein the configuration parameters contain an identification code for the first transponder.

18. The apparatus of claim 1, further comprising a location system to obtain location information from the first radio transponder and transmit it to an access point over the second radio transponder.

19. A method comprising:
communicating through a first radio transponder by backscattering a received signal;
transferring information received through the first radio transponder about communications over a multiple access wireless network through a second radio transponder from the first radio transponder to the second radio transponder, the second radio transponder operating on a multiple access wireless network; and
communicating over the multiple access wireless network through the second radio using the transferred information.

20. An apparatus comprising:
means for communicating through a first radio protocol by backscattering a received signal;
means for communicating over a multiple access wireless network through a second protocol; and
means for transferring information received through the first protocol means about communications through the second protocol means from the first protocol means to the second protocol means.
